(19) United States
(12) Patent Application Publication
(10) Pub. No.: US 2004/0047303 A1
(43) Pub. Date: Mar. 11, 2004

(54) Apparatus, system and method for managing call requests in a communication network providing a plurality of communication services

(76) Inventors: Christopher Lawrence Fernandez, Aurora, IL (US); Donna Michaels Sand, Redmond, WA (US)

Correspondence Address: PATTI & BRILL, ONE NORTH LASALLE STREET, 44TH FLOOR, CHICAGO, IL, 60602, US

(21) Appl. No.: 10/238,337

(22) Filed: Sep. 10, 2002

(51) Int. Cl. H04B 3/36

(52) U.S. Cl. 370/293

(57) ABSTRACT

Information corresponding to a half duplex voice call over a packet network is delivered to unavailable members of a group through alternate communication services. A call request for half duplex voice calls over a packet network is received at a communication server where the call request indicates a group. Packets corresponding to the voice call are converted into an alternate formatted message and delivered, through an alternate communication system, to unavailable members of the group not able to engage in the voice call at the time of the call. The alternate formatted message such as Instant Messaging (IM) message or voice mail message is delivered to the unavailable member when that member is able to receive such a message.

### BACKGROUND OF THE INVENTION

The invention relates in general to communication systems and more specifically to an apparatus, system and method for managing call requests in a communication network providing a plurality of communication services.

Communication systems are increasingly expanding to provide a wide variety of communication services to users. Some of the services currently available include Voice over Internet Protocol (VoIP), Instant Messaging Service (MS), Voice Message Service (VMS) and push-to-talk (PTT).

Some communication techniques utilize packet networks to efficiently provide voice communication between two or more parties. One technique of providing voice communication includes converting audio information into packets that are transmitted over a packet network. VoIP service allows users to engage in a voice conversation over a data network using the Internet Protocol. The data network may be the Internet, an Intranet, or a managed network such as may typically be used by long distance and local service providers or Internet Service Providers (ISPs). Among other benefits, VoIP allows for easier and less expensive integration of new services and efficient system reconfiguration as well as lower transmission costs.

Voice communications over a packet network are often performed using a half duplex configuration. Half duplex allows transmission of information between parties in both directions but in only one direction at any particular time. A party to a half duplex voice call can, therefore, either listen or talk, but not both listen and talk at the same time. A system that provides half duplex voice communication over a packet network is a push-to-talk (PTT) system. PTT systems may utilize a packet network such as the internet to transmit packets corresponding to voice bursts in a voice call. PTT often provide a method for a caller to indicate a group to receive the call allowing for multiple parties to engage in the half duplex voice call.

Conventional half duplex voice systems utilizing packet networks are limited, however, in that unavailable members of the group that are not able to engage in the call at the time the call request is initiated do not have access to the information exchanged during the call. If a member has temporarily turned off their remote unit or is engaged in another call, that unavailable member is omitted from the call established between the caller and the other available members.

Therefore, an efficient apparatus, system and method for managing call requests in a half duplex voice communication system is needed.

### SUMMARY OF THE INVENTION

In an exemplary embodiment of the invention, a communication server manages call requests for half duplex voice communication over a packet network. Information associated with a half duplex voice call is delivered to unavailable members of the group through an alternate communication system. Packets corresponding to the half duplex voice call are converted to an alternate formatted message and delivered to the unavailable members of the group using the alternate communication service provided by the alternate communication system.

### BRIEF DESCRIPTION OF THE DRAWINGS

FIG. 1 is a block diagram of a communication system in accordance with an exemplary embodiment of the invention.

FIG. 2 is a flow chart of a method of managing call requests in accordance with the exemplary embodiment of the invention.

FIG. 3 is a flow chart of a method of delivering an alternate formatted message to unavailable members where the communication system includes a text message service and a voice mail service.

FIG. 4 is a flow chart of a method of delivering a text message corresponding to a half duplex voice call in accordance with the exemplary embodiment of the invention.

### DETAILED DESCRIPTION OF THE PREFERRED EMBODIMENTS

As explained above, conventional communication systems are limited in that users requesting a half duplex call over a packet network such as push-to-talk (PTT) service will not reach members of the desired group if the those members are currently unable to engage in the half duplex call. In accordance with the exemplary embodiment of the invention, an alternate communication service is used to deliver information to unavailable members of the group. Packets associated with the half duplex voice call are converted to an alternate formatted message and delivered to the unavailable members through one or more alternate messaging systems. The alternate communication service may be, for example, a text message service or voice mail service. In the exemplary embodiment, a voice mail service is used only if the unavailable member is not subscribed to a text messaging service.

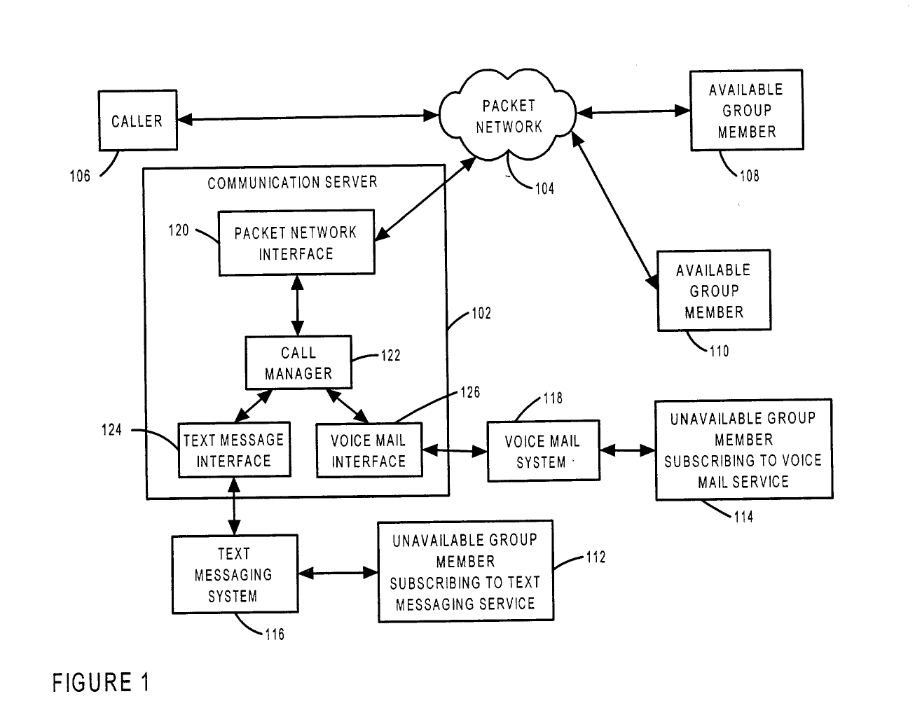

FIG. 1 is a block diagram of a communication system 100 in accordance with the exemplary embodiment of the invention. The various blocks depicted in FIG. 1 may be implemented using any combination of hardware, software, or firmware using known techniques in accordance with the teachings herein. Also, the various blocks illustrate an exemplary configuration and partition of functions. Those skilled in the art will recognize that the various functions and systems may be implemented in other suitable configurations. For example, at least a portion of the text messaging system may be implemented as part of the communication server.

A communication server 102 manages half duplex voice communications over a packet network 104 between users (106-114). The communication server 102 is a computer, server computer, processor or any combination of processors or computers configured to perform the management functions described as well as other management, control and switching tasks associated with the communication system 100. In the exemplary embodiment, software running on the communication server 102 facilitates the overall functionality of the communication server 102 as well as the described functions. An example of a suitable communication server 102 is an enhanced multimedia resource (eMRS) server computer running a suitable operating system such as the Sun operating system. Voice information is exchanged between users by converting the audio voice information into packets, transmitting the packets in accordance with a required data packet protocol such as an Internet Protocol (IP), and converting the packets back into audio voice information. Half duplex communication provides communication in both directions between the parties to a call but allows communication in only one direction at any particular time. Therefore, each party to a half duplex call can receive and transmit information, but can not simultaneously transmit and receive. An example of a system and service providing half duplex communications over a packet network is a push-to-talk PTT system and service. Such services may utilize voice over internet protocol (VoIP) techniques to provide a half duplex communication link between two or more users. Suitable equipment for providing PTT service is manufactured by Lucent Technologies.

The communication server 102 includes at least the appropriate combination of software, hardware or firmware for interfacing to the packet network 104 and the alternate communication system (116, 118). In the exemplary embodiment, the communication server 102 includes a packet network interface 120, a text message interface 124, and a voice mail interface 126. Although the interfaces 120, 124, 126 are depicted as separate blocks in FIG. 1, those skilled in the art will recognize that depending on the particular configuration and implementation of the communication server 102, the interfaces 120, 124, 126 may share any number of resources such as hardware or software. For example, the software facilitating the interface functions of the packet network interface 120, the text message interface 124, and the voice mail interface 126 may run on the same processor within the communication server 102. Further, in circumstances where one or more of the alternate communication systems (116, 118) is implemented as part of the communication server 102, hardware and connections between the functional blocks may be minimized or eliminated.

The call manager 122 running on the communication server 102 performs the functions of managing calls as described herein. The call manager 122 may include any combination of hardware, software or firmware configured to exchange information with the various interfaces 120, 124, 126 and to control the appropriate equipment to facilitate the call management functions. An example of a suitable implementation of the call manager 122 includes running software on the communication server 102 to perform the functions described.

In the exemplary embodiment, the packet network 104 is the Internet and the packets are conveyed in accordance with the Internet Protocol (IP). The packet network 104, however, may be any of several types of packet networks capable of facilitating the communications as described herein. An example of another suitable packet network 104 is an Intranet.

When initiating a half duplex voice communication call, the caller 106 may designate a group that includes users (108-114) that the caller 106 intends to include in a half duplex voice call. The group may include any number of members where, at the time of the call initiation, some members may be available members 108, 110 and some may be unavailable members 112, 114. Available members 108, 110 are members of the group that are available and able to engage in the call and unavailable members 112, 114 are members unable to engage in the half duplex voice call at the time the call is initiated. Each group member may subscribe to one or more alternate communication services in addition to the half duplex voice communication service. In the exemplary embodiment, group members may subscribe to only a text message service (112), only a voice mail service (114), or both a text message service and a voice mail service. The text messaging service is provided by at least one text messaging system 116 and the voice mail service is provided by at least one voice mail system 118. Each of the systems (116, 118) may be comprised of several systems or subsystems. For example, the voice mail system 118 may include two voice mail systems. In the exemplary embodiment, the text messaging system 116 is an Instant Messaging (IM) system. An example of a suitable IM service is the IM service provided by equipment available from Lucent Technologies.

In accordance with the exemplary embodiment, a call request initiated by the caller 106 is transmitted through the packet network 104 and received by the communication server 102 through the packet network interface 120. As explained above, the call request is a request for a half duplex voice call over the packet network 104 that may designate a group of users 108-114 to receive the call. The call manager 122 receives the call request and determines if the members of the designated group are available. The call manager 122 identifies unavailable members 112, 114 and determines if those members 112, 114 subscribe to an alternate communication service. For each unavailable member 112, 114, the call manager 122 converts the packets associated with the call to the appropriate alternate formatted message and forwards the message to the appropriate alternate communication system 116, 118 through the appropriate communication system interface 124, 126. The alternate communication system 116, 118 delivers the alternate formatted message to the unavailable member 114.

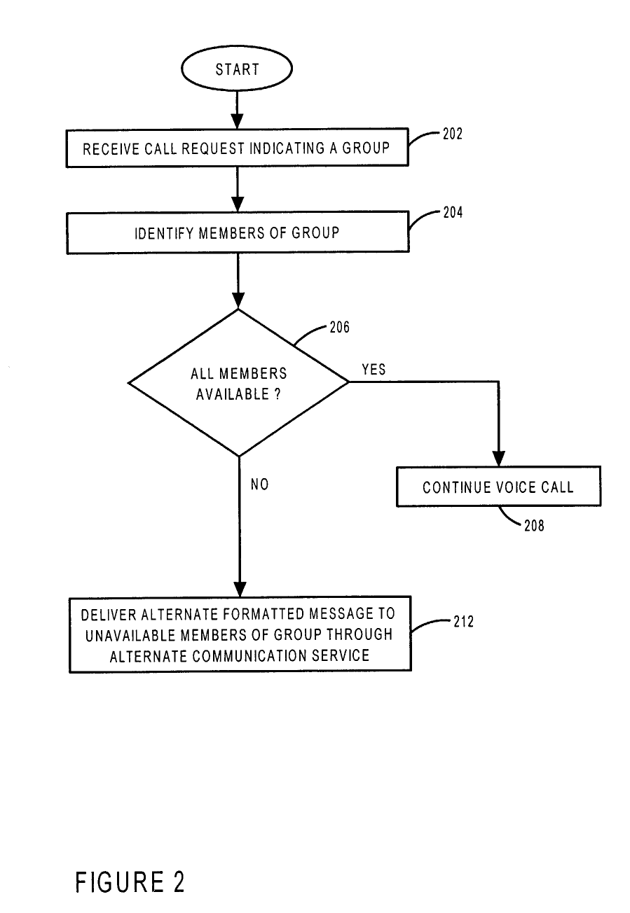

FIG. 2 is flow chart of a method of managing call requests for half duplex voice calls over a packet network 104 in accordance with exemplary embodiment of the invention. The method may be performed using any combination of software, hardware or firmware. In the exemplary embodiment, the method is performed by the call manager 122 by executing software executed within the communication server 102.

At step 202, a call request for a half duplex voice call over a packet network 104 is received where the call request indicates a group. The call request is initiated by a caller 106 and transmitted through the packet network 104 to the communication server in accordance with known techniques. The packet network interface 120 within the communication server 102 forwards the call request to call manager 122.

At step 204, the call manager 122 identifies members of the group. In accordance with known techniques, the call manager 122 interprets the data that indicates the group to identify the users 108 - 114 intended to participate in the half duplex voice call.

At step 206, the call manager 122 determines if all of the members 108 114 of the group are available. A member is determined to be an unavailable member 112, 114 if the member is not currently able to engage in the half duplex voice call over the packet network 104. If all members 108-114 are available, the method continues at step 208 where the half duplex voice call is continued. If at least one member 112, 114 of the group is identified as unavailable, the method continues at step 212.

At step 212, an alternate formatted message is delivered to the unavailable members 112, 114 of the group through an alternate communication service through an alternate communication system 116, 118. The call manager 122 converts each of the packets associated with the voice call into an alternate formatted message. The alternate formatted message can be any message that is formatted in accordance with the requirements of the particular alternate communication system 116, 118. Examples of alternate formatted messages include text messages such a IM messages and voice mail messages. The alternate formatted message is stored and delivered to the unavailable member 112, 114 when the unavailable member 112, 114 is able to receive the alternate formatted message.

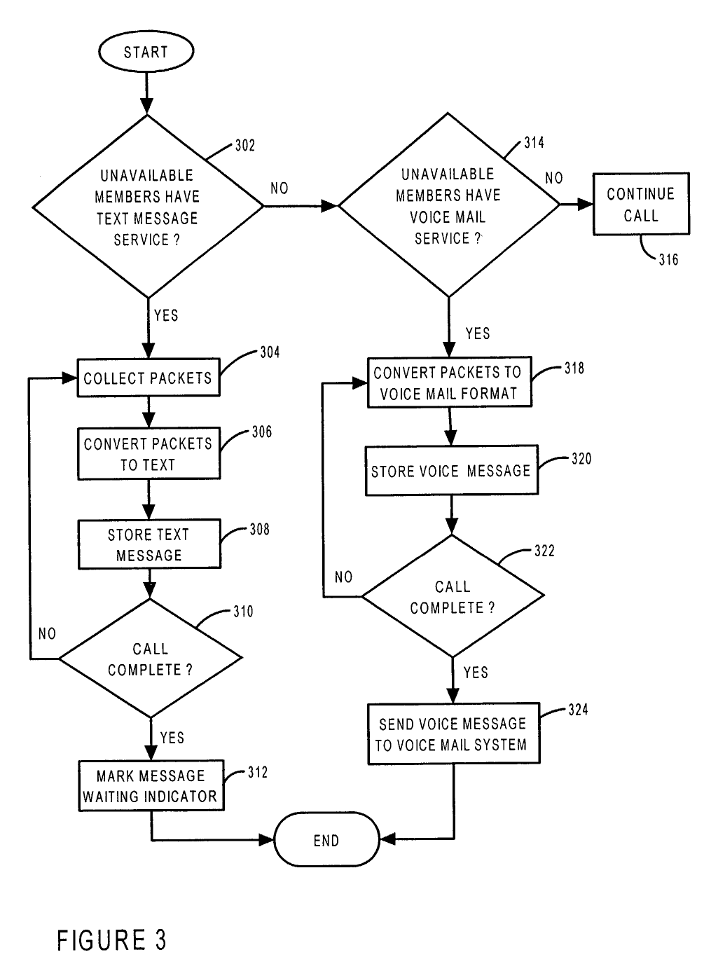

FIG. 3 is a flow chart of method of delivering the alternate formatted message to the unavailable members where the communication system 100 includes a text message service and a voice mail service. Accordingly, the flow chart of FIG. 3 depicts a flow chart of an exemplary method for performing the delivering step 212 described in FIG. 2. Those skilled in the art will recognize that other methods can be used to deliver the alternate formatted message based on these teachings. For example, the alternate communication system (118) may only include a voice mail system 118.

At step 302, the call manger 122 determines if the unavailable members 112, 114 have text message service. If at least one of the unavailable members 112 subscribes to the text message service, the method continues at step 304. If at least one of the unavailable members does not subscribe to the text message service, the method continues at step 314. Therefore, if at least one unavailable member 112 subscribes to the text message service and at least one unavailable member 114 does not subscribe to the text message service, the method continues at both step 304, and step 314. In the exemplary embodiment, the text message service is an instant messaging (IM) service.

At step 304, the call manager 122 collects packets corresponding to the voice call. During the voice call, the call manager 122 identifies the voice over IP corresponding to the voice call and temporarily stores those packets in memory to retain the talk burst information of the call. Each half duplex talk burst is collected to provide a collection of packets representing the voice call and the communications between all the parties to the call.

At step 306, the call manager 122 converts the packets into text. In the exemplary embodiment, the collected packets are converted into the appropriate IM format required by the text messaging system 116.

At step 308, the text message is stored. Each formatted IM message is stored in memory in accordance with known techniques for storing text messages.

At step 310, the call manager 122 determines if the half duplex voice call is complete. If the call is complete, a “Message Waiting” is set in the text message service for the unavailable members. If the call is not complete, the method returns to step 304 and continues to collect and convert packets into the text message as described above.

At step 314, the call manger 122 determines if at least one of the unavailable members (114) that does not have text message service subscribes to the voice mail service. If no members subscribe to the voice mail service, the method continues the voice call at step 316. Otherwise, the method continues at step 318.

At step 318, the packets corresponding to the voice call are converted into a voice mail format as required by the voice mail system 118. The voice mail format may be a digital representation of an audio signal of the conversation in some circumstances.

At step 320, the voice mail message is stored in memory. Any one of various known techniques can be used to store the audio corresponding to the communications between the parties of the call.

At step 322, the call manager 122 determines if the call is complete. If the call is complete, the method continues to step 324 where the voice mail message including the conversation of the voice call is forwarded to the voice mail system. If the call is not complete, the method returns to step 316. The call manager 122, therefore, continues to convert the packets and store the resulting voice mail message for the duration of the half duplex voice call.

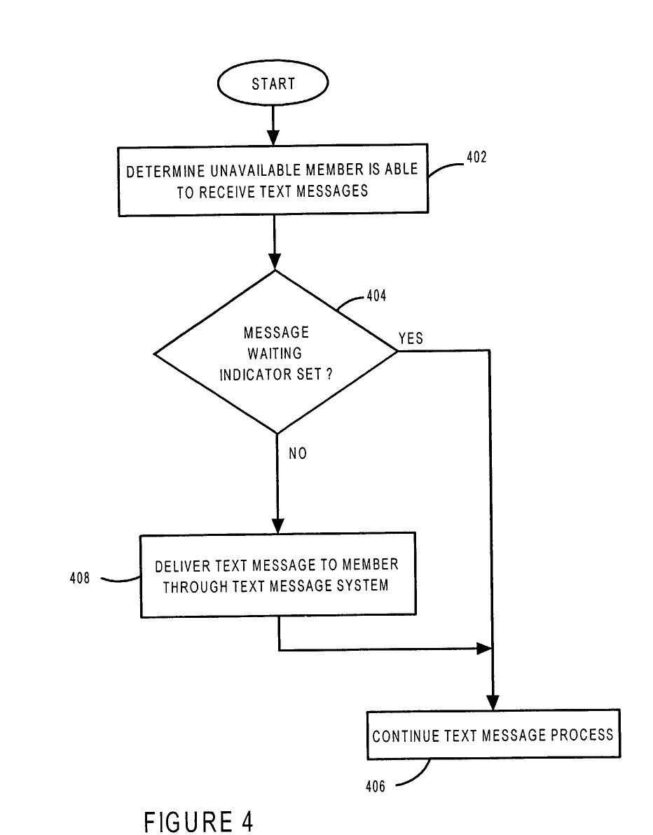

FIG. 4 is a flow chart of method of delivering the text message corresponding to the half duplex voice call in accordance with the exemplary embodiment of the invention. The method is performed by the call manger 122 process in the communication server 102in the exemplary embodiment.

At step 402, the call manger 122 determines that the unavailable member is currently able to receive text messages through the text message service. In the exemplary embodiment, the call manager receives information indicating that the member has logged onto the system. The member may manually log on to the system or the member's device may automatically log on when the device is turned on.

At step 404, the call manger 122 determines if the “Message Waiting” indicator is set for the particular unavailable member 112 currently able to receive text messages. If the indicator is not set, the method continues with the conventional text message process at step 406. If the indicator is set, the method continues at step 408.

At step 408, the text message is delivered to the unavailable member. The call manager 122 retrieves the appropriate stored text message corresponding to the voice call missed by the unavailable member. The text message is forwarded to the text message system 116 which delivers the text message to the unavailable member 112 currently able to receive text messages.

In the exemplary embodiment, therefore, the communication server 102 receives a request for a PTT call and determines if all of the members of the group indicated in the request are available to engage in the PTT call. For members 112 subscribing to the IM service, the communication server, collects the packets corresponding to the talk bursts of the half duplex conversation between the parties, converts the packets into IM text messages and delivers the IM text messages to the unavailable members through the IM system when the unavailable member 112 can receive the IM text message. For unavailable member 114 not subscribing to the IM service and having voice mail service, the communication server 102 converts the packets of the PTT call into a voice mail format to form a voice mail message. The message is forwarded to voice mail system 118 allowing the unavailable member 114 to retrieve the message in accordance with known techniques. Unavailable members 112, 114 are, therefore, able to receive the information exchanged during the PTT call that would have otherwise been inaccessible in conventional systems.

Clearly, other embodiments and modifications of this invention will occur readily to those of ordinary skill in the art in view of these teachings. Therefore, this invention is to be limited only by following claims, which include all such embodiments and modifications when viewed in conjunction with the above specification and accompanying drawings.

We claim:

1. A method for managing call requests for half duplex voice communication over a packet network, the method comprising:
receiving a call request indicating a group; and
for each unavailable member of the group not available to communicate in a half duplex voice call and subscribing to an alternate communication service, converting packets associated with the call into an alternate formatted message and delivering the alternate formatted message to the unavailable members through the alternate communication service.

2. A method in accordance with claim 1, wherein the alternate communication service is a text messaging service and the alternate formatted message is a text message.

3. A method in accordance with claim 2, wherein the text messaging service is an instant messaging (IM) service and the text message is formatted in accordance with the IM service.

4. A method in accordance with claim 1, wherein the alternate service is a voice mail service and the alternate formatted message is voice mail message.

5. A method in accordance with claim 1, wherein the converting comprises:
converting the packets into a text message if the unavailable member subscribes to an instant messaging service and converting the packets into a voice message if the unavailable member subscribes to a voice mail service.

6. A method in accordance with claim 5, wherein the converting further comprises converting the packets to voice mail message only if the unavailable member is not subscribed to the instant messaging service.

7. A method in accordance with claim 1, wherein the half duplex voice communication is a push-to-talk (PTT) service and the packets are transmitted in accordance with an Internet Protocol (IP).

8. A method in accordance with claim 1, further comprising:
collecting the packets associated with the call during the duration of the call and storing the packets.

9. A method in accordance with claim 1, wherein the text message is stored until the unavailable member is available to receive the text message.

10. A method comprising:
receiving a call request for half duplex voice communication over a packet network with members of a group;
identifying unavailable members of the group;
converting packets associated with a half duplex call to a text message; and
delivering the text message to unavailable members of the group.

11. A method in accordance with claim 10, wherein the receiving comprises:
receiving a call request for a push-to-talk (PTT) call.

12. A method in accordance with claim 10, wherein the packet network is an Internet.

13. A method in accordance with claim 10, wherein the delivering the text message comprises:
delivering the text message through an Instant Messaging (IM) service.

14. A method for managing push-to-talk (PTT) call requests for PTT calls established over a packet network, the method comprising:
receiving a PTT call request indicating a group; and
for each unavailable member of the group not available to communicate in a PTT call and subscribing to an alternate service, converting packets associated with the call into an alternate formatted message and delivering the alternate formatted message to the unavailable members through the alternate service.

15. A method in accordance with claim 14, wherein the alternate service is an instant messaging service and the alternate formatted message is a text message.

16. A method in accordance with claim 14, wherein the alternate service is a voice mail service and the alternate formatted message is voice mail message.

17. A method in accordance with claim 14, wherein the converting comprises:
converting the packets into a text message if the unavailable member subscribes to an instant messaging service and converting the packets into a voice message if the unavailable member subscribes to a voice mail service.

18. A method in accordance with claim 17, wherein the converting further comprises converting the packets to voice mail message only if the unavailable member is not subscribed to the instant messaging service.

19. A communication server for managing call requests for half duplex communication over a packet network, communication server comprising:
a packet network interface for receiving a call request for half duplex communication over the packet network, the request identifying a group;
an alternate interface for communicating with an alternate communication service system; and
a call manager for identifying unavailable members of the group not available to communicate in a half duplex call and for converting packets associated with the call into an alternate formatted message and delivering the alternate formatted message to unavailable members subscribing to an alternate communication service provided by the alternate communication service system.

20. A communication server in accordance with claim 19, wherein the alternate interface is for communicating with a text messaging system and the formatted message is a text message.

21. A communication server in accordance with claim 20, wherein the text messaging system is an Instant Messaging (IM) system and the text message is formatted in accordance with an IM service provided by the IM system.

22. A communication server in accordance with claim 19, wherein the alternate communication system interface is a voice mail system and the alternate formatted message is a voice mail message.

23. A communication server in accordance with claim 19, wherein the call manager is for converting the packets into a text message if the unavailable member subscribes to a text messaging service and converting the packets into a voice message if the unavailable member subscribes to a voice mail service.

24. A communication server in accordance with claim 23, wherein the call manager is for converting the packets to a voice mail message only if the unavailable member is not subscribed to the text messaging service.

25. A communication server in accordance with claim 19, wherein the half duplex voice communication is a push-to-talk (PTT) service and the packets are transmitted in accordance with an Internet Protocol (IP).
